(19) United States
(12) Patent Application Publication
(10) Pub. No.: US 2016/0256986 A1
(43) Pub. Date: Sep. 8, 2016

(54) Universal Sink Drain Strainer Wrench

(71) Applicant: Steve Labonte, San Diego, CA (US)

(72) Inventor: Steve Labonte, San Diego, CA (US)

(21) Appl. No.: 14/637,271

(22) Filed: Mar. 3, 2015

(51) Int. Cl. B25B 13/50; B25B 13/06

(52) U.S. Cl. CPC B25B 13/50; B25B 13/065

(57) ABSTRACT

A Universal Sink Drain Strainer Wrench. The wrench should has a ring element that fits over the convention outer sealing ring of a conventional drain strainer. The ring element has a central aperture encircled by a plurality of upwardly-turned engagement tabs. The engagement tabs are sized and spaced so that each engages a face of the conventional outer sealing ring. There is a U-shaped handle element that extends downwardly from the ring element. The U-shaped handle is detachable to allow the wrench to be collapsed into a small package. The user can utilize his or her hands to tighten and loosen the drain strainer sealing ring.

This application is filed within one year of, and claims priority to Provisional Application Ser. No. 62/001,482, filed May 21, 2014.

### BACKGROUND OF THE INVENTION

1. Field of the Invention

This invention relates generally to plumbing tools and fixtures and, more specifically, to a Universal Sink Drain Strainer Wrench.

2. Description of Related Art

Sinks (also known as “wash basins”) are available in a wide variety of shapes, configurations and materials of construction. In virtually all circumstances, the sink drains through a fitting known as a “drain strainer.” FIG. 1 is a cutaway side view of a conventional sink 2 and drain strainer 20. The drain strainer 20 attaches to the drain hole 19 formed in the bottom wall 22 of the sink 2, and provides an attachment point for connecting the sink 2 to the drain system piping (not shown).

The strainer 20 has a hub assembly 17 and an outer sealing ring 28. The hub assembly 17 has an inner strainer plate 24, which seals against the inner surface of the bottom wall 22 of the sink 2 when the strainer 20 is tightened down. The sealing ring 28 threadedly engages the threads 21 on the outer surface of the hub assembly 17. The strainer 20 must be tightened down to affix it to the sink bowl 2, and to prevent leakage.

The problem with the drain strainer 20 is related to the difficulty in installing and/or removing the strainer 20 from the sink 2 when the sink 2 is already in place (i.e. attached to a countertop). The area underneath an installed sink 2 (inside the cabinet) is very congested. Consequently, there rarely is enough room under the sink to use a pipe wrench to either loosen the existing sealing ring 28, or to properly re-tighten the new sealing ring 28 (i.e. on the replacement drain strainer 20). As a result, plumbers have historically dreaded the possibility of replacement of the strainer 20, because it invariably results in skinned knuckles, and many times in a leaking drain.

What is needed is a tool that allows the plumber to remove and re-install a drain strainer 20 in the tight confines of a sink cabinet, and that provides sufficient leverage to make sure that the fittings are tightened securely.

### SUMMARY OF THE INVENTION

In light of the aforementioned problems associated with the prior devices, it is an object of the present invention to provide a Universal Sink Drain Strainer Wrench. The wrench should have a ring element that fits over the convention outer sealing ring of a conventional drain strainer. The ring element should have a central aperture encircled by a plurality of upwardly-turned engagement tabs. The engagement tabs should be sized and spaced so that each engages a face of the conventional outer sealing ring. There should be a U-shaped handle element that extends downwardly from the ring element. The U-shaped handle element should be detachable to allow the wrench to be collapsed into a small package. The user should be able to use their hands to tighten and loosen the drain strainer sealing ring.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a cutaway side view of a conventional sink and drain strainer;

FIG. 2 is an exploded side view of a drain strainer and a preferred embodiment of the universal drain strainer wrench of the present invention;

FIG. 3 is a top view of the ring element of the wrench of FIG. 2;

FIG. 4 is an exploded perspective view of the wrench of FIG. 2;

FIG. 5 is a perspective view of the wrench and strainer of FIG. 2; and

FIG. 6 is another perspective view of the wrench and strainer of FIG. 2.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Universal Sink Drain Strainer Wrench.

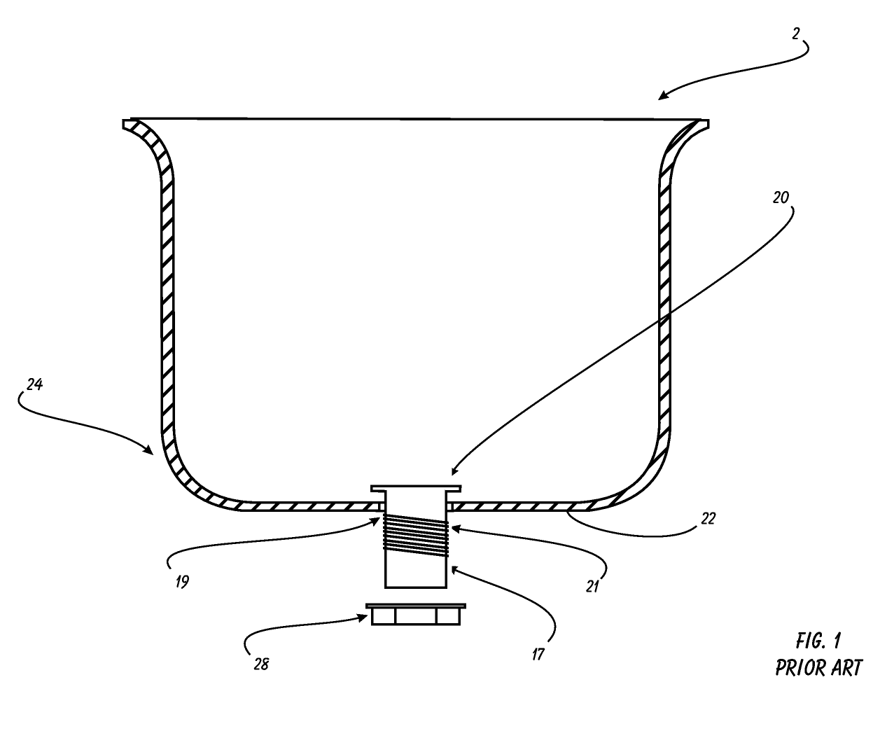

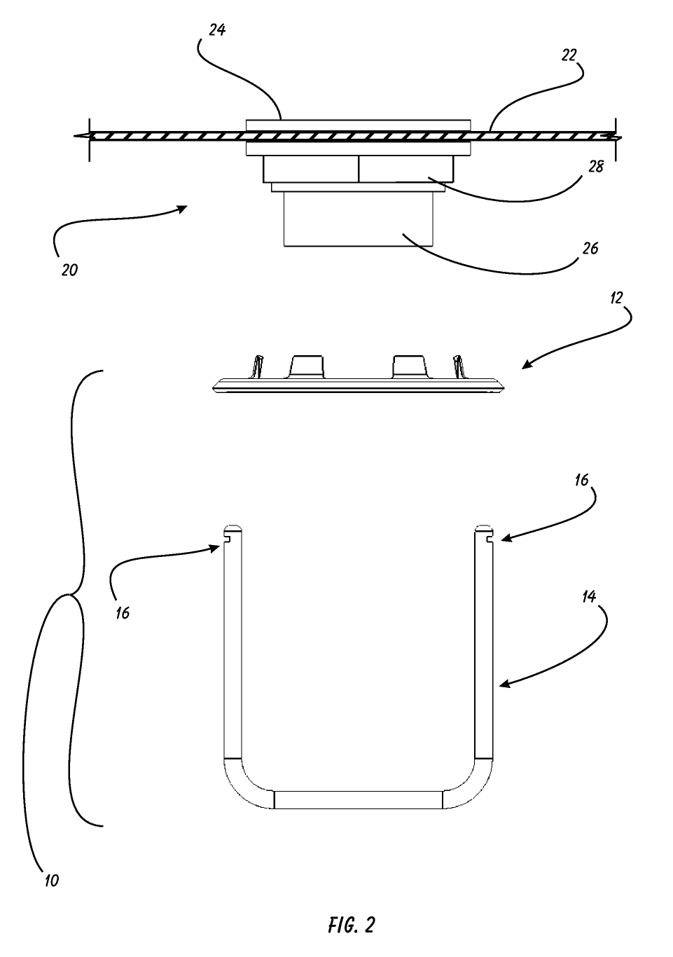

The present invention can best be understood by initial consideration of FIG. 1.¹ FIG. 2 is an exploded side view of a drain strainer 20 and a preferred embodiment of the universal drain strainer wrench 10 of the present invention. The wrench 10 is comprised of two components: the ring element 12, and the handle element 14. The handle element 14 is a U-shaped component made from steel or other hard material. There are a pair of notches 16 formed adjacent to the tips of the handle element 14. These notches 16 serve to engage the ring element 12 when the handle element 14 is attached to the ring element 12. ¹ As used throughout this disclosure, element numbers enclosed in square brackets [ ] indicates that the referenced element is not shown in the instant drawing figure, but rather is displayed elsewhere in another drawing figure.

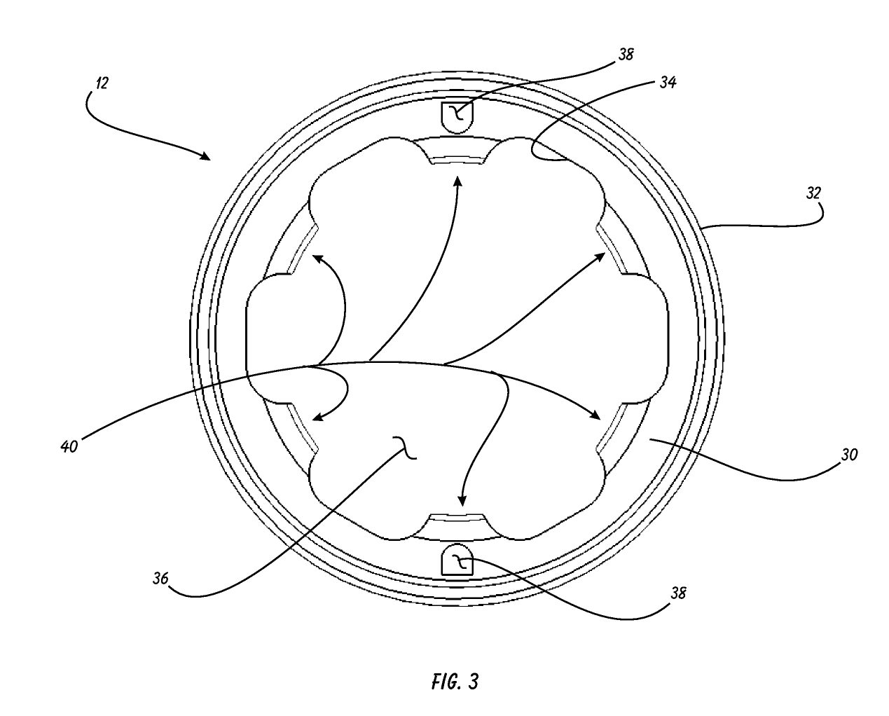

The ring element 12 is designed to fit over the drain hub 26 and then engage the flat faces (i.e. like a large hex nut) of the outer sealing ring 28. The handle element 14 can be attached to and detached from the ring element 12, such as for storage. FIG. 3 provides additional detail regarding the ring element 12.

FIG. 3 is a top view of the ring element 12 of the wrench [10] of FIG. 2. The ring element 12 is defined by a body 30 having a generally circular outer edge 32, and an inner edge 34 encircling a central aperture 36. The ring element 12 can be provided in a variety of sizes so that it can accommodate different sizes of outer sealing rings [28] and drain hubs [26]. There are handle apertures 38 formed in the body 30 at opposing sides thereof. These handle apertures 38 are configured to accept the tips of the handle element [14] therein. As seen here, the outer edges of the handle apertures 38 may be flat in shape so that they engage the notches [16] near the tips of the handle element [14], so that the handle element [14] is retained to the ring element 12 (the handle element [14] is designed so that the tips bias outwardly against the flats of the handle apertures 38 after the handle element [14] tips are inserted into the apertures 38).

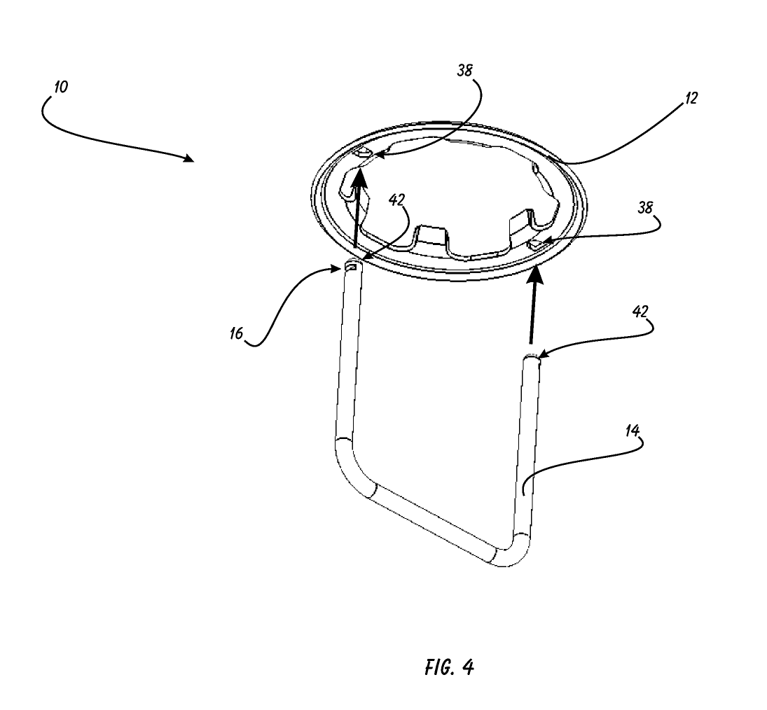

A critical feature of the ring element 12 is the plurality of engagement tabs 40 the encircle the central aperture 36. This engagement tabs 40 act as wrench surfaces for engaging the flat faces of the outer sealing ring [28], approximating a large socket wrench fitting. These tabs 40 are preferably stamped out of the flat piece of metal and then bent upward to form the upwardly-pointing shape (best seen in FIG. 2). The engagement of the handle element 14 with the ring element 12 can be easily seen in FIG. 4.

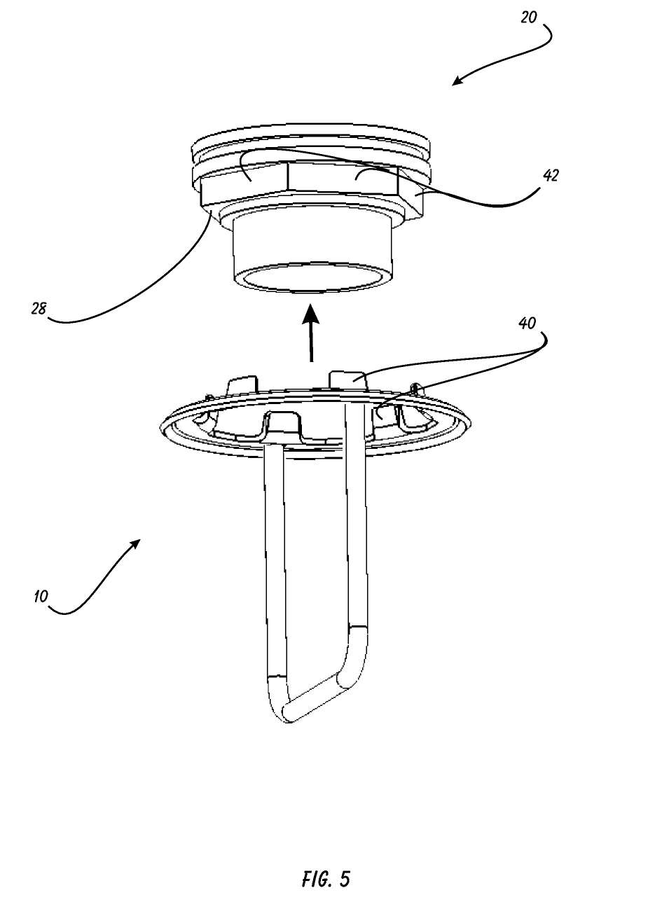

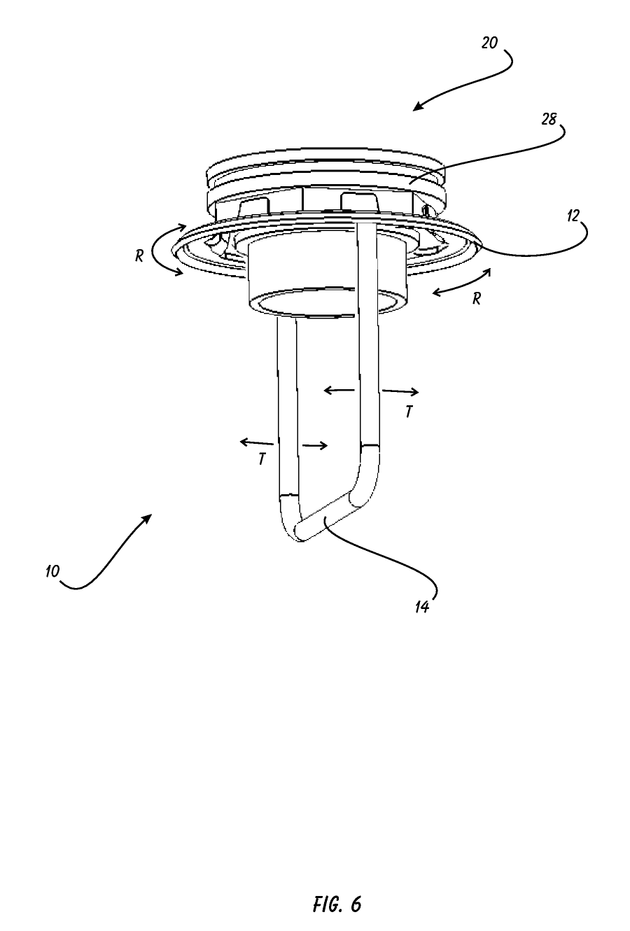

FIG. 4 is an exploded perspective view of the wrench 10 of FIG. 2. As seen, the tips 42 of the handle element 14 are inserted into the handle apertures 38. The tips 42 are preferably spread apart slightly more than the width between the apertures 38 so that there is an interference fit between the notches 16 and the apertures 38 (the tips 42 must be squeezed slightly together in order to insert them into the apertures 38). FIGS. 5 and 6 depict the use of the wrench 10.

FIG. 5 depicts the wrench 10 being positioned for use to tighten or loosen the drain strainer 20. The engagement tabs 40 are configured to align with the engagement faces 42 of the typical outer sealing ring 28. Once in place as shown in FIG. 6, the plumber is able to twist the handle element 14 (in direction “T”). Twisting the handle element 14 will cause the ring element 12 to rotate in direction “R.” In this manner, the outer sealing ring 28 can be either tightened or loosened.

Once the ring 28 is tightened fully, the wrench 10 is removed, and the drain hub 26 can be connected to the rest of the drain system (not shown).

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A wrench for sink drain strainers, wherein said strainers consist of a drain hub defined by external threads and an outer sealing ring threadedly engaging said external threads, the wrench comprising:
a ring element defined by a body comprising a central aperture formed therein, with said central aperture formed to fit over and engage said outer sealing ring; and
a handle element attachable to said ring element whereby by a spatial plane defined by said handle element is generally perpendicular to a spatial plane defined by said body.

2. The wrench of claim 1, wherein said handle element comprises a generally U-shaped element terminating in tips at each end thereof, said handle element attachable to said ring element at said tips.

3. The wrench of claim 2, wherein:
said ring element comprises a pair of handle apertures formed therein; and
said tips are cooperatively formed to be insertible into said handle apertures for said attachability between said handle element and said ring element.

4. The wrench of claim 3, wherein said base comprises a plurality of engagement tabs encircling said central aperture, each said engagement tab positioned to engage a face formed on said outer sealing ring when said ring element is placed over said outer sealing ring.

5. The wrench of claim 4, wherein said engagement tabs are defined by tabs extending towards said central aperture from said base, wherein said tabs are bent upwardly such that they are generally perpendicular to said spatial plane defined by said ring element.

6. The wrench of claim 5, wherein said handle element further comprises a notch formed in said handle element adjacent to each said tip, said notches cooperatively formed to accept a portion of said body therein when said handle element is attached to said ring element by inserting said tips into said handle apertures.

7. A wrench, comprising:
a ring element defined by a body formed from a sheet of metal, said body comprising a central aperture formed therein; and
a handle element attachable to said ring element whereby by a first spatial plane defined by said handle element is generally perpendicular to a second spatial plane defined by said body.

8. The wrench of claim 7, wherein said base comprises a plurality of engagement tabs encircling said central aperture.

9. The wrench of claim 8, wherein said engagement tabs are defined by tabs extending towards said central aperture from said base, wherein said tabs are deformed upwardly such that they are generally perpendicular to said spatial plane defined by said ring element.

10. The wrench of claim 9, wherein said handle element comprises a generally U-shaped element terminating in tips at each end thereof, said handle element attachable to said ring element at said tips.

11. The wrench of claim 10, wherein:
said ring element comprises a pair of handle apertures formed therein; and
said tips are cooperatively formed to be insertible into said handle apertures for said attachability between said handle element and said ring element.

12. The wrench of claim 11, wherein said handle element further comprises a notch formed in said handle element adjacent to each said tip, said notches cooperatively formed to accept a portion of said body therein when said handle element is attached to said ring element by inserting said tips into said handle apertures.

13. A tool for tightening or loosening a large nut defined by a plurality of tangential engagement faces around its periphery, the tool comprising:
a ring element defined by a body formed from a sheet of metal, said body comprising a central aperture formed therein; and
a handle element attachable to said ring element whereby by a first spatial plane defined by said handle element is generally perpendicular to a second spatial plane defined by said body.

14. The tool of claim 13, wherein said base comprises a plurality of engagement tabs encircling said central aperture, said engagement tabs designed to cooperate with said engagement faces whereby one said engagement tab engages one said engagement face when said ring element is placed over said large nut.

15. The tool of claim 14, wherein said engagement tabs are defined by tabs extending towards said central aperture from said base, wherein said tabs are deformed upwardly such that they are generally perpendicular to said spatial plane defined by said ring element.

16. The tool of claim 15, wherein said handle element comprises a generally U-shaped, elongate element terminating in tips at each end thereof, said handle element attachable to said ring element at said tips.

17. The tool of claim 16, wherein:
said ring element comprises a pair of handle apertures formed therein; and
said tips are cooperatively formed to be insertible into said handle apertures for said attachability between said handle element and said ring element.

18. The tool of claim 17, wherein said handle element further comprises a notch formed in said handle element adjacent to each said tip, said notches cooperatively formed to accept a portion of said body therein when said handle element is attached to said ring element by inserting said tips into said handle apertures.
